(19) United States
(12) Patent Application Publication
(10) Pub. No.: US 2019/0176558 A1
(43) Pub. Date: Jun. 13, 2019

(54) Adjustable Spring Bracke

(71) Applicant: ZF Friedrichshagen AG, Friedrichshafen (DE)

(72) Inventors: Josef RENN, Dettelbach (DE); Ralf FAMBACH, Schonungen (DE); Jan ROSSBERG, Schweinfurt (DE); Tom SCHNEIDER, Burkardroth (DE)

(21) Appl. No.: 16/077,793

(22) PCT Filed: Jan. 16, 2017
(86) PCT No.: PCT/EP2017/050746

§ 371 Date: Oct. 10, 2018

(30) Foreign Application Priority Data
Feb. 16, 2016 (DE) 10 2016 202 314.4

(51) Int. Cl. B60G 15/06; B60G 17/02

(52) U.S. Cl. CPC B60G 15/063; B60G 17/0272; B60G 17/021

(57) ABSTRACT

An adjustable spring carrier includes a spring plate. At least one spring plate is axially displaceable by an actuator and is fixed with respect to rotation in circumferential direction relative to a longitudinal axis of the spring carrier. A housing for a drive unit of the actuator and a spring plate abutment surface are connected to one another, and the housing is driven by the actuator for the axial movement of the spring plate.

### CROSS REFERENCE TO RELATED APPLICATIONS

This is a U.S. national stage of application No. PCT/EP2017/050746, filed on Jan. 16, 2017. Priority is claimed on German Application No. DE102016202314.4, filed Feb. 16, 2016, the content of which is incorporated herein by reference.

### BACKGROUND OF THE INVENTION

### 1. Field of the Invention

The invention is directed to an adjustable spring carrier.

### 2. Description of the Prior Art

An adjustable spring carrier comprising a first spring plate and a second spring plate is known from DE 32 23 195 A1. In this adjustable spring carrier, the spacing between the two spring plates can be varied by a pressure medium-operated actuator for selectively preloading a carrying spring arranged between the two spring plates in order to achieve a required carrying force.

A hydraulic medium is used as pressure medium. A pump feeds pressure medium from a reservoir to a cylinder of the actuator. A piston connected to one of the two spring plates is slidingly supported in the cylinder.

As can be seen from the figure, there is a tubing system between the pump, a reservoir and the actuator. The advantage in dividing the components in this way consists in that the entire system can be distributed in a vehicle, and individual components such as the pump or the storage can also be positioned in a vehicle so as to be spatially separated from one another. However, this increases the cost of the tubing and assembly as well as the risk of leaks.

Further, at least one flow valve is required for each vehicle wheel in order to adjust the required vehicle body level or spring preloading of the carrying spring via the spring carrier.

DE 10 2007 004 747 B4 discloses a height adjusting device for wheel suspensions in motor vehicles which has a vibration damper having a damper tube and a carrying spring supported by its ends at least on one side at a spring plate on the damper tube side. The height adjusting device further comprises an adjusting arrangement by which the position of the spring plate on the damper tube side can be varied. The adjusting device has a sleeve element supported at the damper tube so as to be rotatable in itself and held at the damper tube so as to be fixed with respect to axial displacement. When the adjusting device is actuated, an outer sleeve arranged coaxial to the sleeve element is displaced such that the spring plate is also displaced. An achievement of a construction of this type is, in particular, that the carrying spring is not rotated during level adjustment and can accordingly be supported in the usual manner at the body of the motor vehicle. The inner sleeve, the adjusting ring, the spring plate with outer sleeve, and the drive device with the gear unit form an assembly unit, which can be attached to the housing of the vibration damper. Accordingly, motor vehicles can be constructed with or without height adjusting devices without substantial structural modifications.

Further, the inner sleeve can be axially supported by an area with a smaller inner diameter at bulges of the housing of the vibration damper. In particular, it can be provided for this purpose to form pockets at the inner circumference of the inner sleeve and to space these pockets apart from one another viewed in circumferential direction such that the bulges on the damper tube side can engage therein in a substantially positive engagement such that the inner sleeve is supported at the damper tube so as to be fixed with respect to rotation and held axially at the damper tube.

### SUMMARY OF THE INVENTION

It is an object of one aspect of the present invention to realize an adjustable spring carrier that is simple to assemble and in which the entire constructional unit is supported in a defined manner relative to the vibration damper.

The above-stated object is met in that a housing for a drive unit of the actuator and a spring plate abutment surface are connected to one another, and the housing is driven by the actuator for the axial movement of the spring plate.

The spatial arrangement of the actuator relative to the spring carrier is also defined by the relationship of the housing to the spring plate.

In a further advantageous construction, the housing has rotation prevention elements with respect to the longitudinal axis of the spring carrier. Therefore, the housing defines the position of the spring plate relative to the spring carrier.

According to an advantageous aspect, the spring plate forms a positive engagement connection with the housing which is operative in circumferential direction. In principal, the spring plate could also possibly be welded to the housing. However, this would cause thermal stressing of the housing and weldable material combinations would have to be provided. This solution offers the advantage that spring plates having a plastic surface could be used in particular.

The housing can optionally have a guide sleeve for the spring plate. The spring plate can center itself at the guide sleeve and it affords space for the positive engagement connection to the spring plate.

The spring carrier preferably has a carrying cylinder having a rotation prevention profile which is formed by a carrying ring which is fixed in a stationary manner with respect to the carrying cylinder. The advantage of a radial implementation of the carrying cylinder is that it allows a very large number of variants in connection with a standard carrying cylinder.

It is provided that the carrying ring is connected to the carrying cylinder by bonding. “Bonding” can denote any kind of welding or gluing method.

There is a clearance fit between the carrying cylinder and the actuator so that the actuator can be fitted without causing any damage to the surface of the carrying cylinder. The retaining ring has a centering profile in axial direction with respect to an inner cylinder of the actuator so that this clearance can be eliminated again in the assembled state of the actuator. The centering profile can have a conical shape, for example, on which an end face of the inner cylinder is supported.

In a preferred embodiment form, the actuator comprises a pump that supplies a synchronization cylinder of the actuator. The advantage of a synchronization cylinder consists in that a pressure medium need only be pumped between two work chambers. There is no excess volume displaced into a compensation chamber due to different displacer volumes. Consequently, a very small compensation space can be provided which compensates for possible leaks and thermally induced changes in volume.

In a further arrangement, the inner cylinder of the actuator radially limits two work chambers, and the inner cylinder forms a constructional unit with the housing. The inner cylinder can be a simple tube with a circumferential dividing web for axially limiting the work chambers.

Optionally, an axial stop which is positioned independent from bases at the ends of the work chambers can function between the housing and the inner cylinder. The advantage consists in that the entire constructional unit can be grasped at the inner cylinder and moved without loading the end-side bases or possibly cancelling the axial overlapping between the inner cylinder and one of the bases.

A particularly simple constructional form of the axial stop consists in that this axial stop is formed by a radial projection of the housing and a projection of the inner cylinder. A simple retaining ring, for example, can be used for the radial projection in the housing.

In a preferred construction of the invention, the carrying cylinder is a component part of a vibration damper, and the retaining ring is oriented toward a wheel carrier connection.

### BRIEF DESCRIPTION OF THE DRAWINGS

The invention will be described in more detail referring to the following description of the figures.

The drawings show:

FIG. 1 is a view of a spring carrier with actuator for spring plate adjustment;

FIG. 2 is a section from FIG. 2;

FIG. 3 is a further view of FIG. 1;

FIG. 4 is a view of FIG. 1 with spring plate in maximum stroke position; and

FIG. 5 is a section from FIG. 4.

### DETAILED DESCRIPTION OF THE PRESENTLY PREFERRED EMBODIMENTS

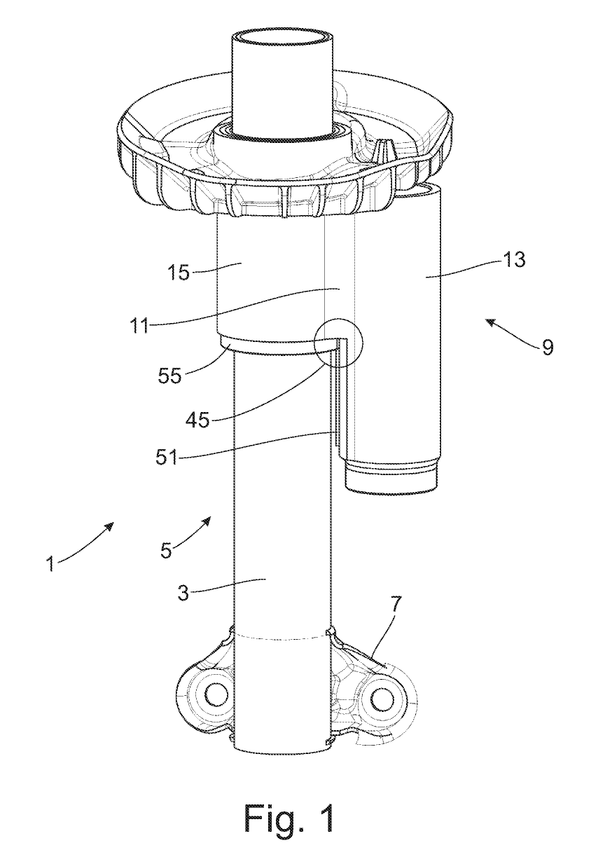

FIG. 1 shows a front view of a spring carrier 1 with a carrying cylinder 3 which is a component part of a vibration damper 5. A piston rod is omitted from the diagram. A wheel carrier connection 7 via which the spring carrier 1 is positioned, e.g., inside a vehicle axle is fastened to a lower end of the carrying cylinder 3. “Positioned” refers in the broadest sense to the height arrangement of the spring carrier 1 and the rotational orientation of the carrying cylinder 3 with respect to the vehicle axle and, accordingly, within a limited installation space.

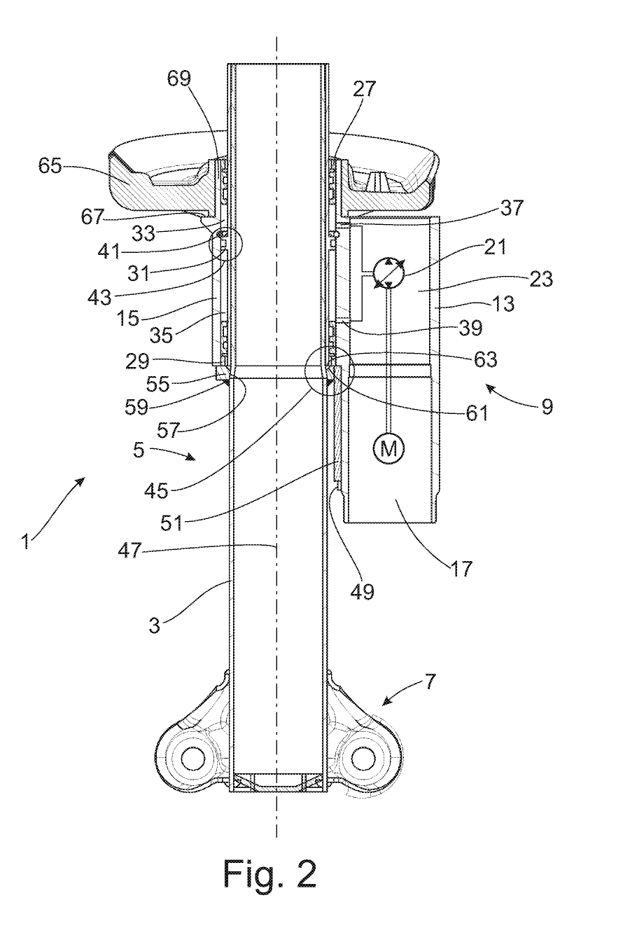

FIGS. 1 and 2 viewed in conjunction show that the spring carrier 1 has an actuator 9 which is arranged in a housing 11. The housing 11 has two parallel cylindrical areas 13; 15. A first cylindrical area 13 has a first receptacle 17 for a drive 19 which acts on a pump 21 in a second receptacle 23. The pump 21 has two feed devices and is preferably controllable. FIG. 2 shows an equivalent diagram to illustrate that the specific construction of the pump and drive is of secondary importance to the invention.

The two cylindrical areas 13; 15 are fixedly connected to one another. In this example, the housing 11 is fashioned in one piece. The second cylindrical area 15 encircles the carrying cylinder 3 and, with an inner cylinder 25, forms a synchronization cylinder as pressure medium-actuated adjusting cylinder. The housing 11 has bases 27; 29 that are fixed at the ends thereof and which, together with a dividing web 31 that is fixed to the inner cylinder 25, forms two work chambers 33; 35 that are in turn connected to the pump 21 via a pressure medium connection 37; 39, respectively. Accordingly, the housing 11 along with inner cylinder 25 forms a handleable constructional unit.

With a radial projection 41 of the housing 11, the dividing web 31 of the inner cylinder 25 forms an axial stop 43 in one of the work chambers 33; 35. For example, the radial projection is formed by a commercially available retaining ring. When the actuator 9 is carried, e.g., during the production process on the inner cylinder 25, this actuator 9 can be displaced relative to the housing 11 until the dividing web 31 contacts the projection 41. The axial stop 43 is positioned in such a way that an axial overlapping of the inner cylinder 25 with the two bases 27; 29 of housing 11 is ensured in all operating states. The advantage of this arrangement consists in that the actuator 9 can be filled with pressure medium and adjusted to be ready for operation completely independently of the further assembly steps.

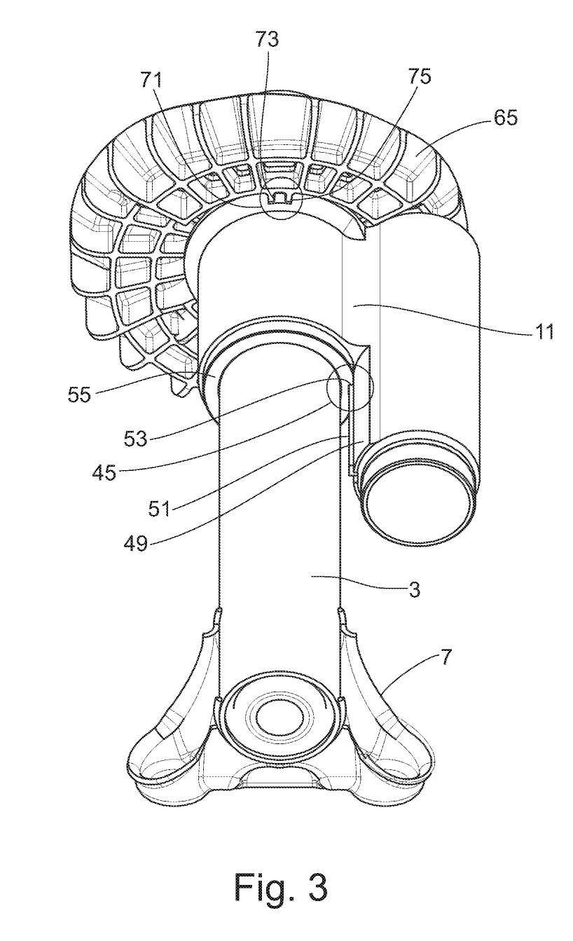

As can been seen particularly from FIG. 3, the housing 11 has elements for preventing rotation with respect to a longitudinal axis 47 of the spring carrier 1. A rod-shaped guide profile 51 engages in a rotation prevention profile 53 of a carrying ring 55, which is fixed so as to be stationary with respect to the carrying cylinder 3 is formed at an outer lateral surface 49 of the first cylindrical area 13. The rotation prevention profile is formed, e.g., by a simple axial groove. In this embodiment example, the carrying ring 55 is supported on a circumferentially extending shoulder 57 of the carrying cylinder 3. However, this arrangement is not compulsory because the carrying ring is preferably connected to the carrying cylinder 3 by bonding. A weld seam 59 is shown by way of example for purposes of illustration.

The carrying ring 55 has on its top a centering profile 61 in the shape of a conical surface. An end face 63 of the inner cylinder 25 is supported on the conical surface 61 such that the inner cylinder 25 is automatically centered with respect to the carrying cylinder 3 via this supporting connection. The preloading for the centering stems purely from the load during operation of the spring carrier 1.

A spring plate 65, which constitutes an independent structural component part in relation to the housing 11, is supported axially on a spring plate abutment surface 67 of the housing 11. The housing 11 has a guide sleeve 69 for the radial positioning of spring plate 65. As is shown in the view according to FIG. 3, a positive engagement connection 71 which is effective in circumferential direction is likewise provided between spring plate 65 and housing 11. For this purpose, the spring plate 65 has a protuberance 73 that engages in a groove 75 on the housing side.

In a first assembly step, the wheel carrier connection 7 is fixed to the carrying cylinder 3. The connection is frequently carried out by welding or another permanent connection. In a further work step, the carrying ring 55 is fitted. Orientation is accomplished at carrying cylinder 3 through the position of the wheel carrier connection 7. Alternatively, e.g., as reference position, the position of a connection member or a stabilizer connection can also be used. It depends only on whether or not there is a fixed point at the carrying cylinder 3 that determines and therefore describes the installation position of the spring carrier 1, e.g., in a vehicle axle.

Before being fastened, the carrying ring 55 is oriented by its rotation prevention profile 53.

In a parallel work step, the housing 11 is outfitted with the radial projection 41 in the work chamber 33. The inner cylinder 25 with its dividing web 31 is subsequently guided into the second cylindrical area 15. The work chambers 33; 35 are defined by fitting the bases 27; 29 at the ends and fixing them in the second cylindrical area 15, and the inner cylinder 25 is prevented from falling out. The pump 21 and drive 19 can then be installed in the first cylindrical area 13. Self-evidently, the pump with the drive can also be fitted first and the inner cylinder can be fitted subsequently. This constructional unit is then filled with pressure medium, vented if need be and then tested for functionality.

Subsequently, the housing 11 with the inner cylinder 25 is fitted on carrying cylinder 3, and the housing-side guide profile 51 engages in the rotation prevention profile 53 until the end face 63 of the inner cylinder 25 contacts the centering profile 61 of the carrying ring 55. The inner cylinder 25 could be rotated relative to the carrying cylinder 3, but the entire housing 11 is fixed with respect to rotation in circumferential direction to the longitudinal axis 47 of the spring carrier 1.

Finally, the spring plate 65 is fitted to the spring plate abutment surface 67 of the housing 11. If necessary, a transport securing device known, e.g., from DE 10 2006 016 470 A1 can be used for the spring plate.

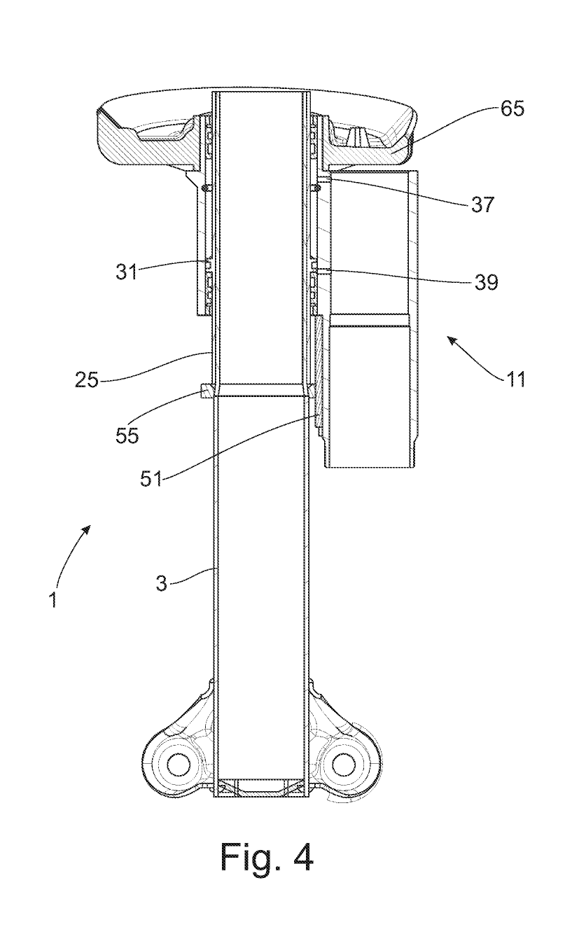

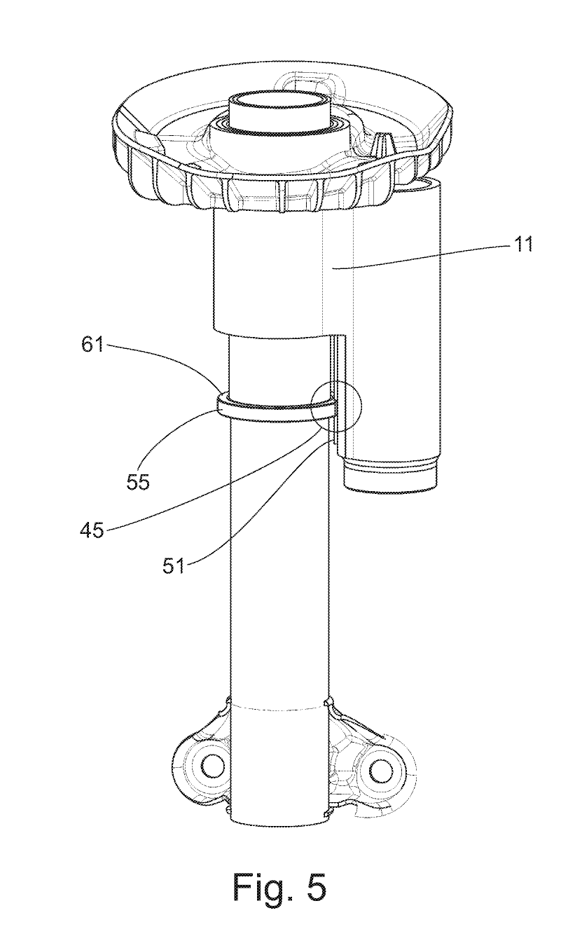

FIGS. 1 to 3 show the actuator 9 and, therefore, the spring plate 65 in a lower stroke position. The spring plate 65 can execute an axial movement by simply pumping the pressure medium volume between the two work chambers 33; 35. The inner cylinder 25 remains in the same position on the carrying ring 55. The housing 11 is displaced relative to the carrying cylinder 3 and relative to the inner cylinder 25 and accordingly carries out the adjusting movement of the spring plate 65 as is shown in FIGS. 4 and 5. If the dividing web 31 of the inner cylinder 15 is seen as a piston, then the cylinder, namely, the housing 11, is displaced in this constructional form.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. An adjustable spring carrier comprising:
an actuator;
a spring plate that is fixed with respect to rotation in circumferential direction relative to a longitudinal axis of the spring carrier and configured to be axially displaceable by the actuator;
a spring plate abutment surface;
a drive unit of the actuator;
a housing for the drive unit of the actuator connected to the spring plate abutment surface and configured to be driven by the actuator for axial movement of the spring plate.

14. The adjustable spring carrier according to claim 13, wherein the housing has at least one rotation prevention element configured to prevent rotation with respect to the longitudinal axis of the spring carrier.

15. The adjustable spring carrier according to claim 14, wherein the spring plate forms a positive engagement connection with the housing that is operative in circumferential direction.

16. The adjustable spring carrier according to claim 13, wherein the housing has a guide sleeve for the spring plate.

17. The adjustable spring carrier according to claim 14, wherein the spring carrier comprises a carrying cylinder having a rotation prevention profile formed by a carrying ring that is fixed in a stationary manner with respect to the carrying cylinder.

18. The adjustable spring carrier according to claim 17, wherein the carrying ring is connected to the carrying cylinder by bonding.

19. The adjustable spring carrier according to claim 17, wherein the carrying ring has a centering profile in axial direction with respect to an inner cylinder of the actuator.

20. The adjustable spring carrier according to claim 13, wherein the actuator comprises a pump that supplies a synchronization cylinder of the actuator.

21. The adjustable spring carrier according to claim 20, wherein an inner cylinder of the actuator radially limits two work chambers, wherein the inner cylinder forms a constructional unit with the housing.

22. The adjustable spring carrier according to claim 21, wherein an axial stop, which is positioned independent from bases at ends of the two work chambers, function between the housing and the inner cylinder.

23. The adjustable spring carrier according to claim 22, wherein the axial stop is formed by a radial projection of the housing and a projection of the inner cylinder.

24. The adjustable spring carrier according to claim 17, wherein the carrying cylinder is a component part of a vibration damper, and the carrying ring is oriented toward a wheel carrier connection.
